(19) United States
(12) Patent Application Publication
(10) Pub. No.: US 2015/0100865 A1
(43) Pub. Date: Apr. 9, 2015

(54) APPARATUS AND METHOD FOR DETERMINING ONE OF CONTROL UNITS TO PERFORM A VERIFICATION PROCESS ON DATA

(71) Applicant: FUJITSU LIMITED, Kawasaki-shi (JP)

(72) Inventor: Yuji Noda, Kahoku (JP)

(73) Assignee: FUJITSU LIMITED, Kawasaki-shi (JP)

(21) Appl. No.: 14/479,865

(22) Filed: Sep. 8, 2014

(30) Foreign Application Priority Data
Oct. 7, 2013 (JP) 2013-210556

(51) Int. Cl. G06F 11/10

(52) U.S. Cl. CPC G06F 11/1076
USPC 714/819

(57) ABSTRACT

Plural control-units each perform a verification process for verifying validity of data. A first storage stores, for each control-unit, an index value indicating a load on the each control-unit activating the verification process, in association with each combination of a rate of a data-amount processed in the verification process executed by the each control-unit and a utilization rate of the each control-unit. A second storage stores, in association with each control-unit, information on a data-amount currently being processed in the verification process activated by the each control-unit and the utilization rate of the each control-unit. A first control-unit determines an index value, for each control-unit, by referring to information in the first storage based on information on a data-amount to be processed in a target verification process and information in the second storage, and determines a second control-unit to activate the target verification process, based on the determined index values.

### CROSS-REFERENCE TO RELATED APPLICATION

This application is based upon and claims the benefit of priority of the prior Japanese Patent Application No. 2013-210556, filed on Oct. 7, 2013, the entire contents of which are incorporated herein by reference.

### FIELD

The embodiments discussed herein are related to apparatus and method for determine one of control units to perform a verification process on data.

### BACKGROUND

Many of storage devices for corporations support the data integrity feature (DIF) control function as a function of ensuring data integrity. The DIF control function is a function of adding an 8-byte check code to each data block (512 bytes) and verifying the validity of the data in order to ensure the integrity of various kinds of data stored in the storage device.

The DIF control function has been standardized by the T10 of the American National Standards Institute (ANSI) and has become a typical function of storage devices for corporations. For this reason, many of general-purpose input/output (I/O) control units (hereafter referred to as “IOCs”) for storage devices is able to perform the DIF control function during input or output of data.

There are some IOCs which additionally have the DIF control function of performing the DIF control function on data in the memory (hereafter referred to as the “memory DIF control function”). Some of large storage devices for corporations include multiple IOCs having the memory DIF control function to improve the functionality and performance thereof.

Further, storage devices have included a high-performance multi-core processor or multiple processors to improve the performance thereof. Storage devices have also employed a method of performing the memory DIF control function using a program executed by some of multiple processors. Further, as storage devices are provided with advanced functionality such as automatic backup or virtualization, the method for transferring data in the storage device and the location in which data is stored in the storage device have been diversified. For this reason, verifying the validity of data using the memory DIF control has become increasingly important, and such verification has been performed very often.

Examples of the related technologies include a technology in which when a load greater than or equal to a first load is imposed on a microprocessor which is to perform an I/O process, the microprocessor assigns the I/O process to another microprocessor (Japanese Laid-open Patent Publication No. 2007-249729). Another related technology is a data transfer control method including comparing the number of data pieces whose errors are detectable by a check code at a certain level with the number of data pieces to be transferred, and outputting a request to stop transfer of the data to be transferred based on the comparison result (Japanese Laid-open Patent Publication No. 11-25008).

### SUMMARY

According to an aspect of the invention, an apparatus includes first and second storage units and a plurality of control units each configured to perform a verification process in which validity of data is verified. The first storage unit stores, for each of the plurality of control units, an index value in association with each of combinations of a first data-amount rate indicating a rate of an amount of data processed in the verification process executed by the each control unit and a utilization rate of the each control unit, the index value indicating a load to be imposed on the each control unit when the each control unit activates the verification process. The second storage unit stores, in association with each of the plurality of control units, a first amount value indicating an amount of data currently being processed in the verification process activated by the each control unit and the utilization rate of the each control unit. A first control unit included in the plurality of control units: determines an index value, for each of the plurality of control units, by referring to information stored in the first storage unit based on a second amount value indicating an amount of data that is to be processed in a target verification process to be executed and information stored in the second storage unit; and determines a second control unit that is to activate the target verification process, from among the plurality of control units, based on the determined index values.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a storage controller, according to an embodiment;

FIG. 2 is a diagram illustrating an example of a configuration of a storage device, according to an embodiment;

FIG. 3 is a diagram illustrating an example of a hardware configuration of a storage controller, according to an embodiment;

FIG. 4 is a diagram illustrating an example of a DIF structure, according to an embodiment;

FIG. 5 is a diagram illustrating an example of an IOC load characteristic table, according to an embodiment;

FIG. 6 is a diagram illustrating an example of a core load characteristic table, according to an embodiment;

FIG. 7 is a diagram illustrating an example of an IOC activation amount table, according to an embodiment;

FIG. 8 is a diagram illustrating an example of a core activation amount table, according to an embodiment;

FIG. 9 is a diagram illustrating an example of a functional configuration of a storage controller, according to an embodiment;

FIG. 10 is a diagram illustrating an example of an operational flowchart for creating an IOC load characteristic table, according to an embodiment;

FIG. 11 is a diagram illustrating an example of an operational flowchart for an I/O process performed by a storage controller, according to an embodiment;

FIG. 12 is a diagram illustrating an example of an operational flowchart for a memory DIF control process performed by a storage controller, according to an embodiment;

FIG. 13 is a diagram illustrating an example of an operational flowchart for an IOC selection process performed by a storage controller, according to an embodiment;

FIG. 14 is a diagram illustrating an example of an operational flowchart for a core selection process performed by a storage controller, according to an embodiment; and

FIG. 15 is a diagram illustrating an example of an IOC/core selection process performed by a storage controller, according to an embodiment.

### DESCRIPTION OF EMBODIMENTS

In the related technologies, when IOCs or processors in a storage device execute the memory DIF control, the balance between the loads imposed on the IOCs and processors is disadvantageously lost, resulting in a reduction in the performance of the storage device.

For example, the related technologies have difficulty in determining which of IOCs or processors is able to efficiently execute the memory DIF control, and therefore the memory DIF control is executed by a particular IOC or processor at the fixed location. In this case, when a particular type or purpose of I/O process is excessively performed in the storage device, the balance between the loads on the IOCs or processors would be lost, resulting in a reduction in the performance of the storage device.

### First Embodiment

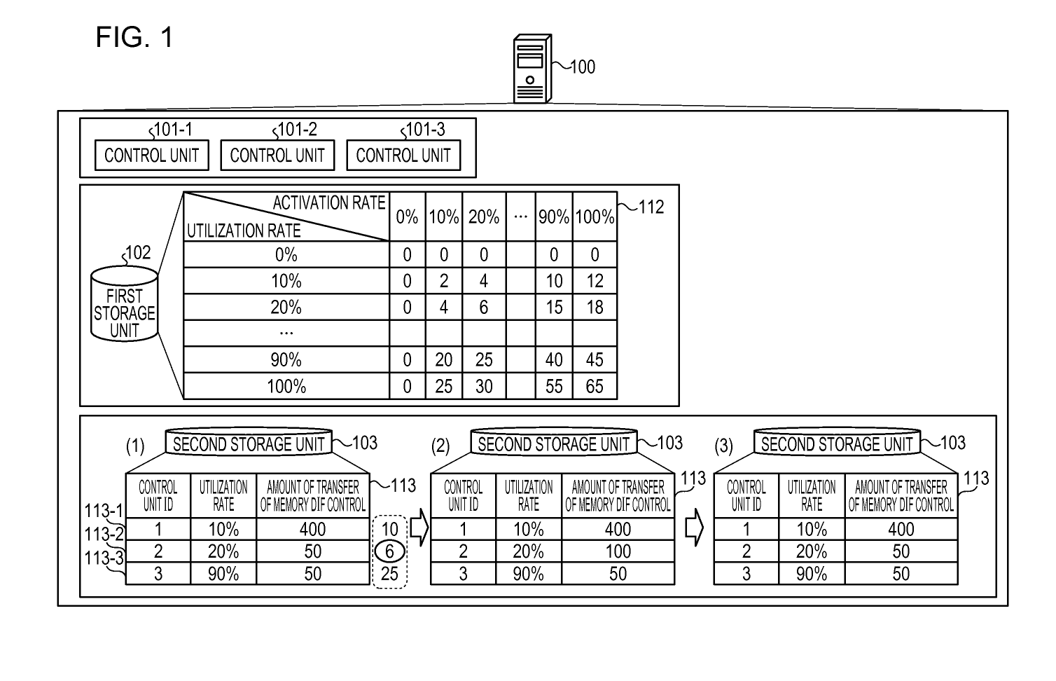

FIG. 1 is a diagram illustrating an example of a storage controller, according to an embodiment. In FIG. 1, the storage controller 100 includes a plurality of control units 101 (in the example of FIG. 1, control units 101-1 to 101-3), a first storage unit 102, and a second storage unit 103.

The storage controller 100 is one component of a storage device and is a computer for controlling the entire storage device. The storage controller 100 receives an I/O request from the host computer and writes data from the host computer to the storage device or reads data from the storage device. A storage device is a device for storing data, and examples of a storage device include, for example, a hard disk, an optical disk, a flash memory, and a magnetic tape.

Each control unit 101 has the memory DIF control function. The memory DIF control function is a function of performing DIF control on data in memory, where the DIF control is a function of adding an 8-byte check code to each data block (512 bytes) and verifying the validity of the data in order to ensure the integrity of data stored in the storage device. The validity of data refers to ensuring, for an application or the like, that all data values are correct and appropriate.

For example, the control unit 101 may be configured using an IOC, a processor, or a core included in a processor. The IOC is an input/output control unit for controlling input or output of data between a peripheral device such as a hard disk, and the memory. Examples of the IOC include Fibre Channel control chips, Serial Attached Small Computer System Interface (SAS) control chips, and Internet Small Computer System Interface (iSCSI) chips. As used herein, the processor is a processor for controlling the storage controller 100 and is, for example, a multi-core processor including multiple cores.

Stored in the first storage unit 102 is a load characteristic table 112. The load characteristic table 112 stores index values each representing a load that is to be imposed on a control unit 101 when the controller 101 activates the memory DIF control, in association with a combination of the utilization rate of the control unit 101 and the activation rate of the memory DIF control of the control unit 101.

For example, the load characteristic table 112 is created by the control units 101 when the storage controller 100 is started. Alternatively, the load characteristic table 112 may be previously created and stored in the storage controller 100 at the time of shipment from the factory. In this case, when the configuration of the storage controller 100 is changed (for example, when the total number or performance of the control units 101 is changed), the load characteristic table 112 may be re-created by the control units 101.

The utilization rate of the control unit 101 refers to the ratio of the current throughput of the control unit 101 to the maximum possible throughput thereof. For example, assuming that the control unit 101 is an IOC, the utilization rate of the control unit 101 may be the ratio of the number of I/Os that the IOC is currently activating to the maximum number of I/Os that are executable per unit time by the IOC.

The activation rate of the memory DIF control of the control unit 101 refers to a data-amount rate that is a rate of an amount of data processed in the verification process executed by the control unit 101. In this case, the ratio of the amount of data which the control unit 101 processes in the memory DIF control being executed by the control unit 101 to the maximum amount of data which the control unit 101 is able to process in the memory DIF control per unit time may be used as the activation rate. For example, assuming that the control unit 101 is an IOC, the activation rate may be the ratio of the amount of data which the IOC processes in the memory DIF control being executed by the control unit 101 to the maximum amount of data which the IOC is able to process in the memory DIF control per unit time.

The index value representing a load refers to the rate of performance reduction of a control unit 101 having a certain utilization rate when the control unit 101 executes the memory DIF control at a certain activation rate. For example, when a control unit 101 having a certain utilization rate executes the memory DIF control at a certain activation rate, the index value representing a load is the ratio of the amount of data which the control unit 101 has failed to process in the memory DIF control within a unit time, to the amount of data which the control unit 101 has processed in the activated memory DIF control.

For example, assume that the utilization rate of the control unit 101 is 10% and the activation rate of the memory DIF control of the control unit 101 is 20%. In the case, in the example of FIG. 1, the index value representing a load is 4. Accordingly, assuming that the amount of data which the control unit 101 has processed in the activated memory DIF control is 100, the amount of data which the control unit 101 has processed in the memory DIF control within the unit time becomes 96.

Stored in the second storage unit 103 is an activation amount table 113. The activation amount table 113 stores, in association with each of the control units 101 (control units 101-1 to 101-3), the utilization rate of the each control unit 101 and the amount of data transferred in the memory DIF control. For example, the activation amount table 113 includes records each having the fields of a control unit ID, a utilization rate, and an amount of transfer of memory DIF control. By setting information in each field, pieces of memory DIF control execution amount information (for example, pieces of memory DIF control execution amount information 113-1 to 113-3) are stored as records.

In the case, “control unit ID” refers to the identifier of a control unit 101. “Utilization rate” refers to the utilization rate of the control unit 101. “Amount of transfer of memory DIF control” refers to the amount of data which the control unit 101 processes in the activated memory DIF control. The amount of data processed in the memory DIF control is expressed in blocks. One block is, for example, 512 bytes or 520 bytes.

In the first embodiment, one of the control units 101 (in this case, “control unit 101-1”), with reference to load characteristics (load characteristic table 112) of each control unit 101 when the each control unit 101 activates the memory DIF control, predicts a load to be imposed on the each control unit 101 having activated the memory DIF control, based on the load situations (activation amount table 113) of control units 101 being operated, and determines a control unit 101 which is to activate the memory DIF control. Hereafter, there will be described an example of data processing performed by the storage controller 100 according to the first embodiment.

(1) The control unit 101-1 determines a target control unit 101 which is to activate the memory DIF control to be executed. Hereinafter, a verification process, such as the memory DIF control, to be executed will also expressed as “a target verification process”. For example, first, the control unit 101-1 determines the amount of data transferred in the memory DIF control to be executed. Then the control unit 101-1 calculates the activation rate of the memory DIF control, for each of the control units 101-1 to 101-3, based on the total amount of transfer data obtained by summing up the determined amount of data transferred in the memory DIF control to be executed and the corresponding amount of data transferred in memory DIF control stored in the activation amount table 113.

Then, with reference to the load characteristic table 112, the control unit 101-1 determines, for each of the control units 101-1 to 101-3, an index value representing a load that corresponds to the calculated activation rate of the memory DIF control and the utilization rate in the activation amount table 113. Then, the control unit 101-1 determines a control unit 101 having the index value that is smallest among index values representing loads determined for the control units 101-1 to 101-3, as a target control unit 101 which is to execute the memory DIF control to be executed.

In the example of FIG. 1, it is assumed that the amount of data transferred in the memory DIF control to be executed is 50 and that the maximum amount of data transferred in the memory DIF control, which is achievable per unit time by each of the control units 101-1 to 101-3, is 500. It is also assumed that the amount of data transferred in memory DIF control of the control unit 101-1, which is stored in the activation amount table 113, is 400. Accordingly, the summation of the amount of data transferred in the memory DIF control to be executed and the amount of data transferred in the memory DIF control of the control unit 101-1 gives 450.

Since the maximum amount of data which the control unit 101-1 is able to process in the memory DIF control per unit time is 500, the activation rate of the memory DIF control becomes 90%. Further, since the utilization rate of the control unit 101-1 stored in the activation amount table 113 is 10%, the utilization rate and activation rate of the control unit 101-1 stored in the load characteristic table 112 are 10% and 90%, respectively. Accordingly, the index value representing the load to be imposed on the control unit 101-1 becomes 10.

Similarly, the index value representing the load on the control unit 101-2 becomes 6, and the index value representing the load on the control unit 101-3 becomes 25. Then control unit 101-1 determines the control unit 101-2 having the index value that is smallest among the control units 101-1 to 101-3, as a target control unit 101 which is to execute the memory DIF control to be executed.

(2) The control unit 101-1 updates the record corresponding to the determined target control unit 101 in the activation amount table 113. In the example of FIG. 1, the target control unit 101 is the control unit 101-2, and the amount of data transferred in the memory DIF control to be executed by the target control unit 101 (the control unit 101-2) is 50. Accordingly, the control unit 101-1 updates the amount of data transferred in memory DIF control which is stored in the record 113-2 of the activation amount table 113 so that a value thereof becomes 100.

(3) In response to the target control unit 101 completing the memory DIF control to be executed, the control unit 101-1 updates the record that is associated with the target control unit 101 in the activation amount table 113. Specifically, since the target control unit 101 is the control unit 101-2 and the amount of data transferred in the memory DIF control to be executed is 50 in the example of FIG. 1, the control unit 101-1 updates the amount of data transferred in memory DIF control which is stored in the record 113-2 of the activation amount table 113 so that a value thereof becomes 50.

As described above, the storage controller 100 according to the first embodiment may be configured to predict respective loads to be imposed on the control units 101 when the control units 101 activate the memory DIF control to be executed. The storage controller 100 then determines a target control unit 101 which is to activate the memory DIF control and which is less likely to reduce the performance of the storage device, from among the control units 101, based on the predicted loads to be imposed on the control units 101.

### Second Embodiment

In a second embodiment, multiple control units 101 include multiple IOCs for controlling I/O of the storage device, and a processor including multiple cores. Each of an IOC and a core has the memory DIF control function. One of the cores of the processor determines an IOC or a core which is to execute the memory DIF control.

Example of System Configuration of Storage Device 200

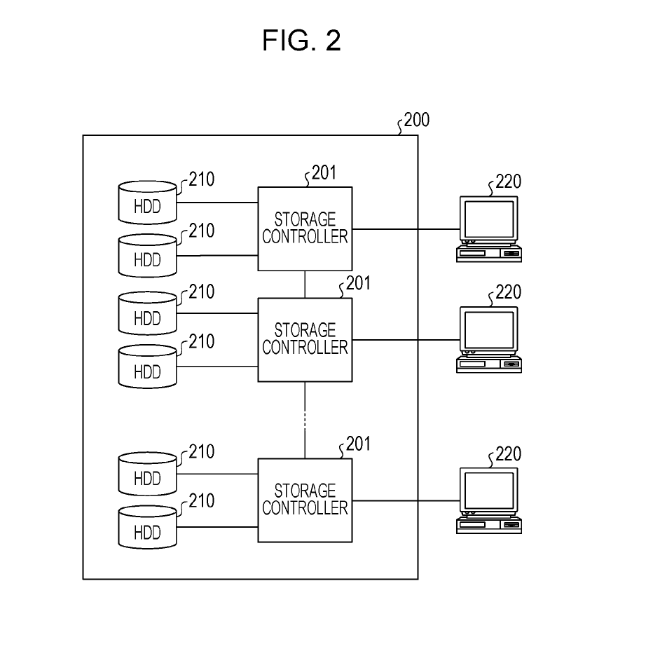

FIG. 2 is a diagram illustrating an example of a configuration of a storage device, according to an embodiment. In FIG. 2, the storage device 200 includes multiple storage controllers 201 and multiple storage units 210. The storage device 200 is connected to multiple host computers 220 through an interface such as Fibre Channel, SAS, or iSCSI. The storage device 200 may be connected to the host computers 220 through a network such as a local area network (LAN), wide area network (WAN), or the Internet.

The storage controller 201 is a computer for controlling the entire storage device 200. The storage units 210 each include a hard disk drive (HDD) and a hard disk. Each hard disk drive controls read or write of data from or to the corresponding hard disk under the control of the corresponding storage controller 201. Each hard disk stores data written under the control of the corresponding hard disk drive. The storage unit 210 may be configured to include a solid state drive (SSD). Each storage controller 201 corresponds to the storage controller 100 of FIG. 1.

Example Hardware Configuration of Storage Controller 201

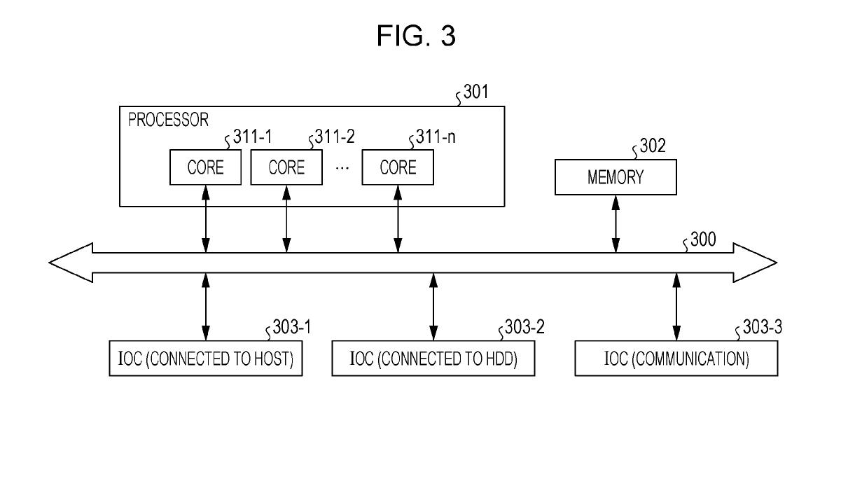

FIG. 3 is a diagram illustrating an example of a hardware configuration of a storage controller, according to an embodiment. The storage controller 201 includes a processor 301 including multiple cores 311-1 to 311-n; a memory 302, and multiple IOCs 303-1 to 303-3. The multiple IOCs 303 include an IOC 303-1 (connected to the host), an IOC 303-2 (connected to HDD), and an IOC 303-3 (communication). These components are connected with each other via a bus 300. The cores 311 and the IOCs 303 each have the memory DIF control function.

The processor 301 controls the entire storage controller 201. The memory 302 includes, for example, a read only memory (ROM), a random access memory (RAM), and a flash ROM. For example, the flash ROM or ROM stores programs, and the RAM serves as a work area of the processor 301. When the programs stored in the memory 302 are loaded to the processor 301, the programs cause the processor 301 to perform processes coded therein.

The IOC 303-1 (connected to the host) is connected to the host computers 220 to control input/output (I/O) of data to and from the host computers 220. The IOC 303-2 (connected to the HDD) is connected to the HDD to control I/O of data to and from the HDD. The IOC 303-3 (communication) is connected to the other storage controllers 201 to control I/O of data to and from the other storage controllers 201.

The processor 301 and the IOCs 303 correspond to the control units 101 of FIG. 1, and the memory 302 corresponds to the first storage unit 102 and the second storage unit 103 of FIG. 1.

Example of DIF Structure

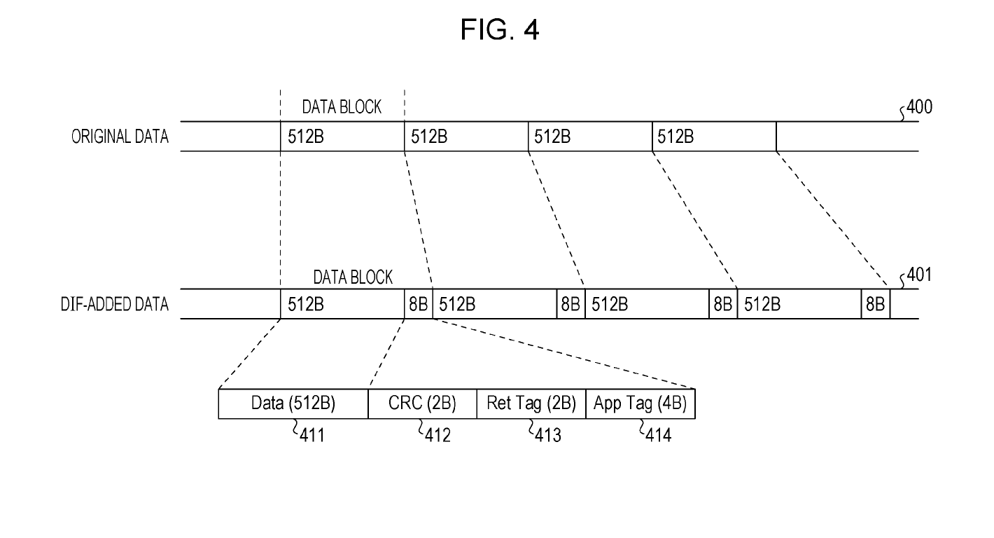

FIG. 4 is a diagram illustrating an example of DIF structure, according to an embodiment. The storage device 200 performs, on a block basis, I/O of data to and from the host computers 220, and I/O of data stored in the storage unit 210, such as a HDD. In an example of FIG. 4, I/O is executed in units of 512 bytes. The DIF control function adds an 8-byte check code to each block of original data 400 to generate DIF-added data 401 in order to verify the validity of data.

Each 8-byte check code includes a cyclic redundancy check (CRC) 412 of a data block 411, a reference tag 413, and an application tag 414 defined by an application.

The CRC 412 is the output value of an error detection function that inputs the data block 411. The error detection function is a function that inputs a data stream having any length and outputs a fixed-size value, such as a 32-bit integer. The memory DIF control function verifies the validity of the data block 411 by using the CRC 412. For example, logical block addressing (LBA) is set to the reference tag 413, where LBA is a value representing the position of data in the storage unit 210, such as the HDD. For example, IOCID, which is the identifier of the IOC 303, is set in the application tag 414.

Example of IOC Load Characteristic Table 500

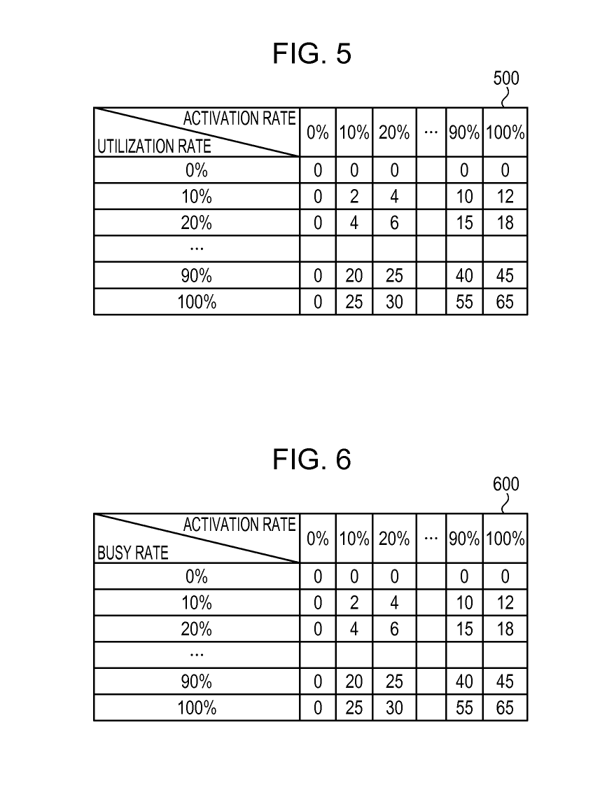

FIG. 5 is a diagram illustrating an example of an IOC load characteristic table, according to an embodiment. For example, an IOC load characteristic table 500 is created by a creation unit 901 (to be discussed later) and stored in the memory 302.

The IOC load characteristic table 500 stores index values LF_{I} each representing a load that is to be imposed on an IOC 303 when the memory DIF control is activated under the condition indicated by a combination of the utilization rate of the IOC 303 and the activation rate of the memory DIF control executed by the IOC 303. In an example of FIG. 5, the IOC load characteristic table 500 stores index values LF_{I} each representing a load to be imposed on the IOC 303 corresponding to a combination of the utilization rate of the IOC 303 ranging from 0% to 100% in increments of 10% and the activation rate of the memory DIF control of the IOC 303 ranging from 0% to 100% in increments of 10%.

The utilization rate of the IOC 303 refers to the ratio of the number of I/O currently being activated by the IOC 303 to the maximum number of I/O executable by the IOC 303 per unit time. The activation rate of the memory DIF control of the IOC 303 refers to the ratio of the amount of data processed in the memory DIF control being activated, to the maximum amount of data that is able to be processed per unit time in the memory DIF control by the IOC 303.

The index value LF_{I} representing a load to be imposed on an IOC 303 refers to a rate of performance reduction of an IOC 303 having a certain utilization rate when the IOC 303 activates the memory DIF control having a certain activation rate. For example, when an IOC 303 having a certain utilization rate activates the memory DIF control having a certain activation rate, the index value LF_{I} representing a load is a ratio of the amount of data that has failed to be processed in the memory DIF control within a unit time, to the amount of data to be processed for the activated memory DIF control.

Example of Core Load Characteristic Table 600

FIG. 6 is a diagram illustrating an example of a core load characteristic table, according to an embodiment. For example, a core load characteristic table 600 is created by the creation unit 901 (to be described later) and stored in the memory 302.

The core load characteristic table 600 stores index values LF_{C} each representing a load to be imposed on a core 311 under the condition corresponding to a combination of a busy rate of the core 311 and an activation rate of the memory DIF control of the core 311. In an example of FIG. 6, the core load characteristic table 600 stores index values LF_{C} each representing a load to be imposed on an IOC 303 under the condition corresponding to a combination of a busy rate of the core 311 ranging from 0% to 100% in increments of 10% and an activation rate of the memory DIF control of the core 311 ranging from 0% to 100% in increments of 10%.

The busy rate of the core 311 refers to the percentage of the time during which the operating system (OS) or application software performs some process. The activation rate of the memory DIF control of the core 311 refers to a ratio of the amount of data processed in the memory DIF control being activated by the control unit 311, to the maximum amount of data that the core 311 is able to process per unit time in the memory DIF control.

The index value LF_{C} representing a load to be imposed on a core 311 refers to a rate of performance reduction of a core 311 having a certain busy rate when the core 311 activates the memory DIF control having a certain activation rate. For example, when a core 311 having a certain busy rate activates the memory DIF control having a certain activation rate, an index value representing a load is a ratio of the amount of data that has failed to be processed in the memory DIF control within a unit time, to the amount of data processed in the activated memory DIF control. For example, assume that the busy rate of a core 311 is 10% and the activation rate of the memory DIF control of the core 311 is 20%. In this case, in an example of FIG. 6, the index value LF_{C} representing a load is 4. Accordingly, assuming that the amount of data processed in the activated memory DIF control is 100, the amount of data that has been processed in the memory DIF control within a unit time becomes 96.

Example of IOC Activation Amount Table 700

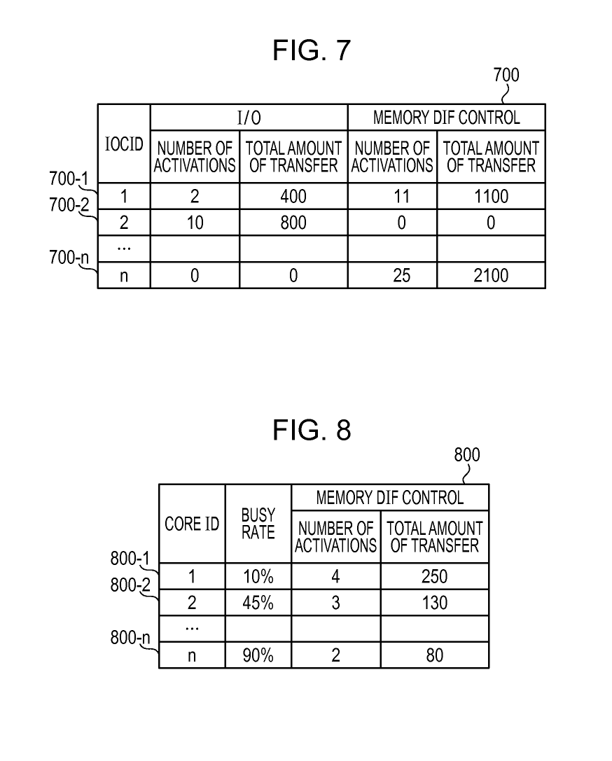

FIG. 7 is a diagram illustrating an example of an IOC activation amount table, according to an embodiment. The IOC activation amount table 700 stores, in association with each of the IOCs 303, the current utilization rate thereof and the amount of data transferred in the memory DIF control. For example, an IOC activation amount table 700 is created by the creation unit 901 (to be described later), stored in the memory 302, and updated by an update unit 902 (to be described later). The IOC activation amount table 700 has the fields of an IOCID, the number of activations of I/O, a total amount of transfer of I/O, the number of activations of memory DIF control, and a total amount of transfer of memory DIF control. By setting information in the fields of the IOC activation amount table 700, pieces of IOC activation amount information (for example, pieces of IOC activation amount information 700-1 to 700-n) are stored as records.

In the example of FIG. 7, “IOCID” refers to the identifier of an IOC 303. “Number of activations of I/O” refers to the number of I/Os activated by the IOC 303. “Total amount of transfer of I/O” refers to the amount of data processed in I/O activated by the IOC 303. “Number of activations of memory DIF control” refers to the number of activations of the memory DIF control activated by the IOC 303. “Total amount of transfer of memory DIF control” refers to the amount of data processed in the memory DIF control activated by the IOC 303. In the example of FIG. 7, IOC execution amount information 700-1 represents that the IOCID of an IOC 303 is “1”, the number of activations of I/O is “2”, the total amount of transfer of I/O is “400”, the number of activations of the memory DIF control is “11”, and the total amount of transfer of the memory DIF control is “1100”.

Example of Core Activation Amount Table 800

FIG. 8 is a diagram illustrating an example of a core activation amount table, according to an embodiment. The IOC activation amount table 800 is a table that stores, in association with each of the cores 311, the current busy rate thereof and the amount of data transferred in the memory DIF control. For example, a core activation amount table 800 is created by the creation unit 901 (to be described later), stored in the memory 302, and updated by the update unit 902 (to be described later). The core activation amount table 800 has the fields of a core ID, a busy rate, the number of activations of memory DIF control, and a total amount of transfer of memory DIF control. By setting information in the fields of the core activation amount table 800, pieces of core execution amount information (for example, pieces of core execution amount information 800-1 to 800-n) are stored as records.

In the example of FIG. 8, “core ID” refers to the identifier of a core 311. “Busy rate” refers to the busy rate of the core 311. “Number of activations of memory DIF control” refers to the number of activations of the memory DIF control activated by the core 311. “Total amount of transfer of memory DIF control” refers to the amount of data processed in the memory DIF control activated by the core 311. In an example of FIG. 8, core execution amount information 800-1 represents that the core ID of a core 311 is “1”, the busy rate thereof is “10%”, the number of activations of the memory DIF control is “4”, and the total amount of transfer of memory DIF control is “250”.

Example Functional Configuration of Storage Controller 201

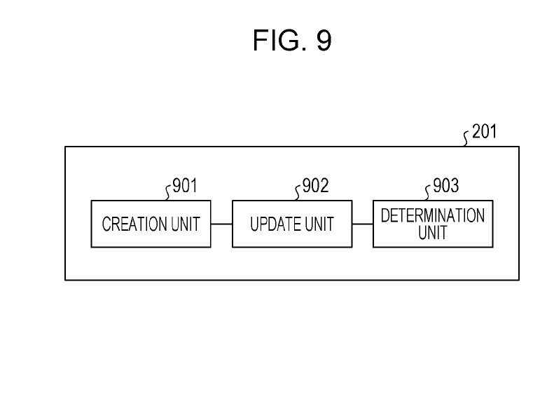

FIG. 9 is a diagram illustrating an example of a functional configuration of a storage controller, according to an embodiment. In FIG. 9, the storage controller 201 includes the creation unit 901, the update unit 902, and a determination unit 903. For example, these function units are realized by causing the processor 301 to execute a program loaded into memory, such as the memory 302 shown in FIG. 3. The results of processes performed by the function units are stored, for example, in a memory, such as the memory 302 illustrated in FIG. 3.

The creation unit 901 has a function of creating an IOC load characteristic table 500 and a core load characteristic table 600, and storing them in the memory 302. The creation unit 901 creates an IOC load characteristic table 500 and a core load characteristic table 600, for example, when the storage controller 201 is shipped from the factory, when the storage controller 201 is started up, or when the configuration of the storage controller 201 is changed.

The creation unit 901 also has a function of generating, for each of the IOCs 303, a record of the IOC activation amount table 700, generating, for each of the cores 311, a record of the core activation amount table 800, and storing the generated records in the memory 302. The creation unit 901 creates an IOC activation amount table 700 and a core activation amount table 800, for example, when the storage controller 201 is started up. Details of processes performed by the creation unit 901 will be described later.

The update unit 902 has a function of updating the IOC activation amount table 700 and the core activation amount table 800 stored in the memory 302. Details of processes performed by the update unit 902 will be described later.

The determination unit 903 has a function of determining an IOC 303 or core 311 which is to activate the memory DIF control to be executed. For example, the determination unit 903 determines an IOC 303 having the smallest index value LF_{I} representing a load and a core 311 having the smallest index value LF_{C} representing a load. The determination unit 903 then determines one of the determined IOC 303 and core 311 having the smaller index value as an IOC 303 or core 311 which is to activate the memory DIF control.

The determination unit 903 then determines the amount of data transferred in the memory DIF control to be executed. The determination unit 903 then calculates, for each of the IOCs 303, an activation rate of the memory DIF control, based on the total amount of transfer that is obtained by summing up the determined amount of data transferred in the memory DIF control and the total amount of data transferred in the memory DIF control which is stored in the activation amount table 700. For example, the determination unit 903 calculates the activation rate of the memory DIF control by dividing the summed-up total amount of transfer by the maximum amount of data transferred in the memory DIF control which the IOC 303 is able to activate per unit time.

The determination unit 903 then calculates the utilization rate of each IOC 303, based on the total amount of data transferred in I/O which is stored in the IOC activation amount table 700. For example, the determination unit 903 calculates the utilization rate of each IOC 303 by dividing the total amount of transfer of I/O which is stored in the IOC activation amount table 700 by the maximum amount of data transferred in the I/O which the IOC 303 is able to execute per unit time.

The determination unit 903 then determines, for each of the IOCs 303, based on the IOC load characteristic table 500, an index value LF_{I}, which represents a load to be imposed on the each IOC 303, corresponding to the calculated activation rate of the memory DIF control and the calculated utilization rate of the each IOC 303. The determination unit 903 then determines, from among the IOCs 303, an IOC 303 having the smallest index value LF_{I} representing a load.

The determination unit 903 calculates the activation rate of the memory DIF control for each of the cores 311, based on the total amount of transfer data obtained by summing up the determined amount of data transferred in the memory DIF control to be executed and the total amount of transfer of memory DIF control which is stored in the core activation amount table 800. For example, the determination unit 903 calculates the activation rate of the memory DIF control by dividing the summed-up total amount of transfer data by the maximum amount of data transferred in the memory DIF control which the each core 311 is able to activate per unit time.

Next, the determination unit 903 determines, from the core load characteristic table 600, an index value LF_{C}, which represents a load to be imposed on each of the cores 311, corresponding to a combination of the calculated activation rate of the memory DIF control and the busy rate stored in the core activation amount table 800. The determination unit 903 then determines, from among the cores 311, a core 311 having the smallest index value LF_{C}.

The determination unit 903 then makes a comparison between the determined index value LF_{I} representing a load to be imposed on the IOC 303 and the determined index value LF_{C} representing a load to be imposed on the core 311, and determines one of the IOC 303 and the core 301 having the smaller index value, as an IOC 303 or core 311 which is to execute the memory DIF control.

Details of Process of Creation Unit 901

Hereafter, details of a process performed by the creation unit 901 will be described.

Creation of IOC Load Characteristic Table 500

Each IOC 303 performs the memory DIF control, as well as I/O control, such as read or write from or to the HDD and data transfer from the host computer. When an IOC 303 is caused to simultaneously perform I/O control and the memory DIF control, the shared resources in the IOC 303 are used competitively. Thus, a delay in I/O or a reduction in performance of the memory DIF control occurs compared to the case where these types of control are executed separately.

The performance reduction characteristics of each IOC 303 vary depending on the amount of activation of I/O or the amount of activation of the memory DIF control. To grasp the performance reduction characteristics, the creation unit 901 actually causes each IOC 303 to activate I/O control and the memory DIF control, and then creates an IOC load characteristic table 500 storing index values LF_{I} representing loads to be imposed on the respective IOCs 303. The creation unit 901 creates an IOC load characteristic table 500 as follows.

(1) The creation unit 901 causes each IOC 303 to continuously activate a predetermined amount of I/O and sets the utilization rate of the IOC 303 at a predetermined utilization rate (j %). For example, assuming that an IOC 303 has a capability of performing I/O 100 times within a unit time, the creation unit 901 sets the utilization rate of the IOC 303 at 10% by activating I/O ten times within the unit time.

(2) The creation unit 901 causes each IOC 303 to activate the memory DIF control in which a predetermined amount of data (m blocks) is processed and sets the activation rate of the memory DIF control of the IOC 303 at a predetermined activation rate (k %). For example, assume that an IOC 303 has a capability of executing the memory DIF control in which 500 data blocks are processed within a unit time. In this case, the creation unit 901 sets the activation rate of the memory DIF control of the IOC 303 at 10% by causing the IOC 303 to activate the memory DIF control in which 50 data blocks are processed within the unit time.

(3) The creation unit 901 detects the amount of data (n blocks) which the IOC 303 has failed to process in the memory DIF control per unit time.

(4) The creation unit 901 calculates an index value LF_{I} representing a load that is to be imposed on the IOC 303 under the condition indicated by a combination of the utilization rate (j %) of the IOC 303 and the activation rate (k %) of the memory DIF control of the IOC 303, by using Formula (1) below.

LF_{I}=(n/m)×100 (1)

(5) The creation unit 901 repeats (1) to (4) by changing the utilization rate (j %) of the IOC 303 and the activation rate (k %) of the memory DIF control of the IOC 303, in predetermined increments, for example, in increments of 10%. Thus, the creation unit 901 calculates index values LF_{I} representing loads to be imposed on the IOCs 303 corresponding to combinations of the utilization rate (j %) of the IOC 303 of 0% to 100% and the activation rate (k %) of the memory DIF control of the IOC 303 of 0% to 100%. The creation unit 901 then stores the calculated index values LF_{I} in the IOC load characteristic table 500.

(6) The creation unit 901 repeats (1) to (5) with respect to all the IOCs 303, thereby creating an IOC load characteristic table 500 for each of the IOCs 303.

Creation of Core Load Characteristic Table 600

Each core 311 of the processor 301 performs the memory DIF control, as well as controls the storage controller 201. For this reason, when a core 311 activates the memory DIF control, the performance of the memory DIF control varies depending on the activation rate of the memory DIF control of the core 311 and the busy rate of the core 311. To grasp the performance reduction characteristics, the creation unit 901 activates the memory DIF control at a predetermined busy rate for each core 311, and creates a core load characteristic table 600 storing index values LF_{C} representing loads to be imposed on the respective cores 311. The creation unit 901 creates a core load characteristic table 600 as follows.

(1′) The creation unit 901 sets the busy rate of a core 311 at a predetermined busy rate (j %). For example, the creation unit 901 sets the busy rate of the core 311 at the predetermined busy rate by starting a program which imposes a load on the core 311.

(2′) The creation unit 901 causes the core 311 to activate the memory DIF control in which a predetermined amount of data (m′ blocks) is processed and sets the activation rate of the memory DIF control of the core 311 at a predetermined activation rate (k %). For example, assume that the core 311 has a capability of executing the memory DIF control in which 500 data blocks are processed within a unit time. In this case, the creation unit 901 sets the activation rate of the memory DIF control of the core 311 at 10% by causing the core 311 to activate the memory DIF control in which 50 data blocks are processed per unit time.

(3′) The creation unit 901 detects the amount of data (n′ blocks) which the core 311 has failed to process in the memory DIF control within the unit time.

(4′) The creation unit 901 calculates an index value LF_{C} representing a load that is to be imposed on the IOC 303 under the condition indicated by a combination of the busy rate (j %) of the core 311 and the activation rate (k %) of the memory DIF control of the core 311, by using Formula (2) below.

LF_{C}=(n′/m′)×100 (2)

(5′) The creation unit 901 repeats (1′) to (4′) by changing the busy rate (j %) of the core 311 and the activation rate (k %) of the memory DIF control of the core 311 in predetermined increments, for example, in increments of 10%. Thus, the creation unit 901 calculates index values LF_{C}, representing loads to be imposed on the core 311, corresponding to combinations of the busy rate (j %) of the core 311 of 0% to 100% and the activation rate (k %) of the memory DIF control of the core 311 of 0% to 100%. The creation unit 901 then stores the calculated index values LF_{C} in the core load characteristic table 600.

(6′) The creation unit 901 repeats (1′) to (5′) with respect to all the cores 311, and creates a core load characteristic table 600 for each core 311.

Details of Process by Update Unit 902

Hereafter, details of processes performed by the update unit 902 will be described.

Update of IOC Activation Amount Table 700

(1) When an IOC 303 receives an I/O request, the update unit 902 increments, by 1, the number of activations of I/O in a record of the IOC 303 which is stored in the IOC activation amount table 700. The update unit 902 also adds the amount of data transferred based on the I/O request to the total amount of transfer of I/O in the record of the IOC 303 which is stored in the IOC activation amount table 700.

(2) When the IOC 303 completes I/O requested by the received I/O request, the update unit 902 decrements, by 1, the number of activations of I/O in a record of the IOC 303 which is stored in the IOC activation amount table 700. The update unit 902 also subtracts the amount of data transferred based on the I/O request from the total amount of transfer of I/O in the record of the IOC 303 which is stored in the IOC activation amount table 700.

(3) When the determination unit 903 determines that an IOC 303 is to activate the memory DIF control, the update unit 902 increments, by 1, the number of activations of the memory DIF control in a record of the IOC 303 which is stored in the IOC activation amount table 700. The update unit 902 also adds the amount of data transferred in the memory DIF control to the total amount of transfer of memory DIF control in the record of the IOC 303 which is stored in the IOC activation amount table 700.

(4) After an IOC 303 completes the memory DIF control, the update unit 902 decrements, by 1, the number of activations of the memory DIF control in a record of the IOC 303 which is stored in the IOC activation amount table 700. The update unit 902 also subtracts the amount of data transferred in the memory DIF control from the total amount of transfer of memory DIF control in the record of the IOC 303 which is stored in the IOC activation amount table 700.

Update of Core Activation Amount Table 800

(1′) The update unit 902 periodically updates the busy rate stored in the core activation amount table 800 by using the busy rate acquisition function of the OS running on the core 311. The update unit 902 may acquire the busy rate by periodically interrupting the OS running on the core 311 and periodically collecting the operating state or idle state of the task. The task refers to an execution unit of a process seen from the OS. The operating state of the task represents a state in which the core 311 is executing a program, and the idle state of the task is a state in which there is no program to be executed.

(2′) When the determination unit 903 determines that a core 311 is to activate the memory DIF control, the update unit 902 increments, by 1, the number of activations of the memory DIF control in a record of the core 311 which is stored in the core activation amount table 800. The update unit 902 also adds the amount of data transferred in the memory DIF control to the total amount of transfer of memory DIF control in the record of the core 311 which is stored in the core activation amount table 800.

(3′) After the core 311 completes the memory DIF control, the update unit 902 subtracts, by 1, the number of activations of the memory DIF control in a record of the core 311 which is stored in the core activation amount table 800. The update unit 902 also subtracts the amount of data transferred in the memory DIF control from the total amount of transfer of memory DIF control the record of the core 311 which is stored in the core activation amount table 800.

Creation of IOC Load Characteristic Table 500 by Storage controller 201

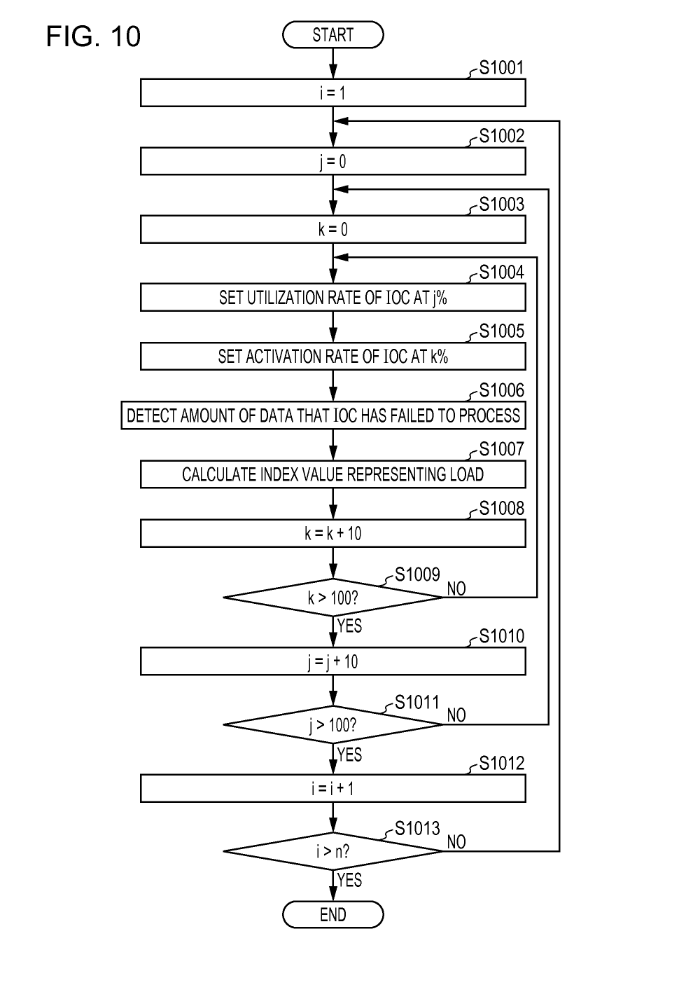

FIG. 10 is a diagram illustrating an example of an operational flowchart for creating an IOC load characteristic table, according to an embodiment, which is performed by a storage controller 201. In the flowchart of FIG. 10, first, the creation unit 901 sets i representing the ID of an IOC 303 at 1 (step S1001). Then the creation unit 901 sets j representing the utilization rate of the IOC 303 at 0 (step S1002), and sets k representing the activation rate of the memory DIF control at 0 (step S1003).

Then the creation unit 901 causes the IOC 303 to continuously activate a predetermined amount of I/O and increases the utilization rate of the IOC 303 to a predetermined utilization rate (j %) (step S1004). The creation unit 901 also causes the IOC 303 to activate the memory DIF control in which a predetermined amount of data is processed, and increases the activation rate of the memory DIF control of the IOC 303 to a predetermined activation rate (k %) (step S1005).

Then the creation unit 901 detects the amount of data which the IOC 303 has failed to process in the memory DIF control within the unit time (step S1006). The creation unit 901 then calculates the ratio of the amount of data which the IOC 303 has failed to process in the memory DIF control within the unit time, to a predetermined amount of data, as an index value LF_{I} representing a load to be imposed on the IOC 303 (step S1007).

The creation unit 901 then increments k by 10 (step S1008) and checks whether k is greater than 100 (step S1009). When k is not greater than 100 (NO in step S1009), the process proceeds to step S1004, and the creation unit 901 calculates an index value LF_{I} representing a load to be imposed on the IOC 303 at the incremented activation rate (k %) of the memory DIF control.

When k is greater than 100 (YES in step S1009), the creation unit 901 increments j by 10 (step S1010), and checks whether j is greater than 100 (step S1011). When j is not greater than 100 (NO in step S1011), the process proceeds to step S1003, and the creation unit 901 calculates an index value LF_{I} representing a load to be imposed on the IOC 303 at the incremented utilization rate (j %) of the IOC 303.

When j is greater than 100 (YES in step S1011), the creation unit 901 increments i by 1 (step S1012), and checks whether i is greater than n indicating the number of IOCs (step S1013). When i is not greater than n (NO in step S1013), the process proceeds to step S1002, and the creation unit 901 calculates an index value LF_{I} representing a load to be imposed on an IOC 303 having the incremented IOCID “i”.

When i is greater than n (YES in step S1013), the creation unit 901 ends the process for creating an IOC load characteristic table.

A core load characteristic table 600 of the storage controller 201 is created in the operations similar to those described in the flowchart for creating an IOC load characteristic table 500. For example, in step S1004, the creation unit 901 increases the busy rate for the core ID “i” to j % by causing the core 311 to start a program which imposes a load on the core 311. Then, in step S1005, the creation unit 901 increases the activation rate of the memory DIF control of the core 311 to a predetermined activation rate (k %) by causing the core 311 to activate the memory DIF control in which a predetermined amount of data is processed. Then, in step S1006, the creation unit 901 detects the amount of data which the core 311 has failed to process in the memory DIF control within the unit time. Then, in step S1007, the creation unit 901 calculates the ratio of the amount of data which the core 311 has failed to process within the unit time, to a predetermined amount of data, as an index value LF_{C} representing a load to be imposed on the core 311. Thus, a core load characteristic table 600 of the storage controller 201 is created.

I/O Process by Storage Controller 201

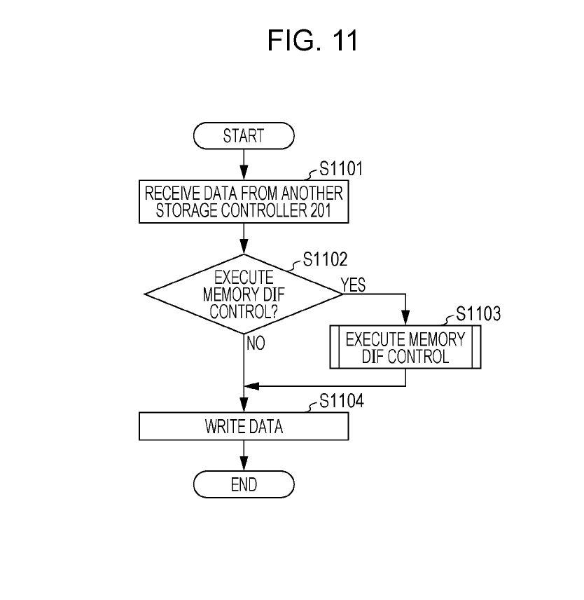

FIG. 11 is a diagram illustrating an example of an operational flowchart for an I/O process performed by a storage controller, according to an embodiment. In the flowchart of FIG. 11, first, the storage controller 201 receives an I/O request, and an IOC 303 thereof receives data from another storage controller 201 (step S1101). The received data is loaded into the memory 302. Then the storage controller 201 determines whether the memory DIF control is to be executed on the data loaded into the memory 302 (step S1102).

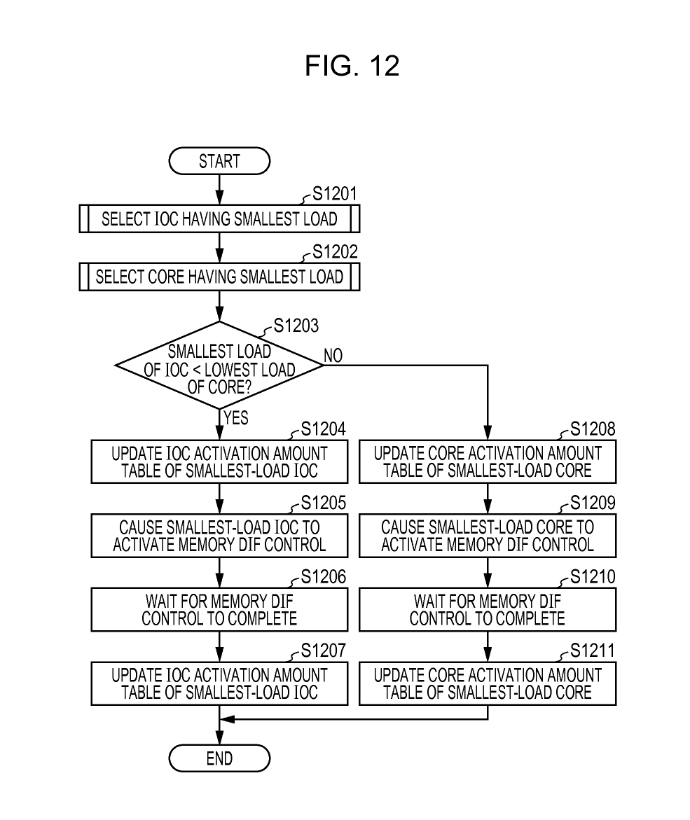

When the storage controller 201 determines that the memory DIF control is to be executed (YES in step S1102), the storage controller 201 executes the memory DIF control (step S1103). Details of the memory DIF control executed by the storage controller 201 will be described below with reference to FIG. 12. After the storage controller 201 completes the memory DIF control, the process proceeds to step S1104.

When the storage controller 201 determines that the memory DIF control is to be executed (NO in step S1102), the storage controller 201 writes the data loaded into the memory 302 to a corresponding storage unit 210 (step S1104). Thus, the storage controller 201 ends the I/O process.

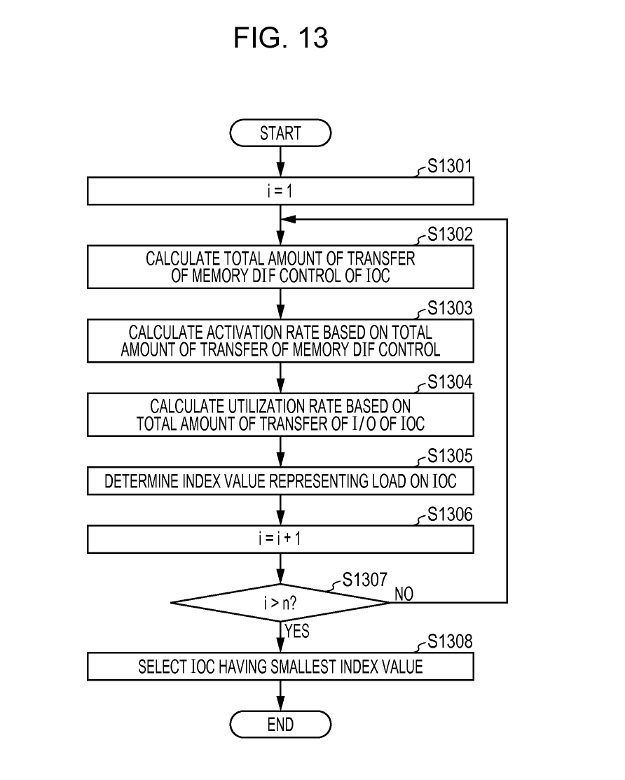

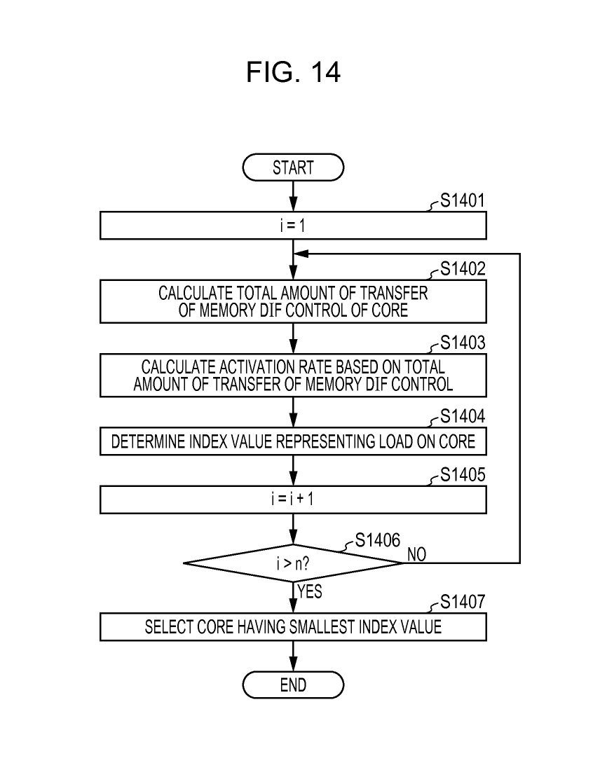

FIG. 12 is a diagram illustrating an example of an operational flowchart for a memory DIF control process performed by a storage controller, according to an embodiment. In the flowchart of FIG. 12, first, the determination unit 903 selects an IOC 303 having the smallest load (step S1201). Details of the smallest-load IOC 303 selection process performed by the determination unit 903 will be described later with reference to FIG. 13. Then the determination unit 903 selects a core 311 having the smallest load (step S1202). Details of the smallest-load core 311 selection process performed by the determination unit 903 will be described later with reference to FIG. 14.

The determination unit 903 then determines whether the smallest load of the IOC 303 is smaller than the smallest load of the core 311 (step S1203). Specifically, the determination unit 903 makes a comparison between the index value LF_{I} (indicating the load of the IOC 303) that has been calculated to select the smallest-load IOC 303 in step S1201 and the index value LF_{C} (indicating the load of the core 311) that has been calculated to select the smallest-load core 311 in step S1202. When the index value LF_{I} indicating the load of the IOC 303 is smaller, the determination unit 903 determines that the smallest load of the IOC 303 is smaller than the smallest load of the core 311 (YES in step S1203).

The determination unit 903 then updates the record of the smallest-load IOC 303 in the IOC activation amount table 700 (step S1204). Specifically, the determination unit 903 increments the number of activations of the memory DIF control of the smallest-load IOC 303 by 1, as well as adds the amount of data transferred in the memory DIF control to be executed, to the total amount of transfer of memory DIF control of the smallest-load IOC 303.

The determination unit 903 then causes the smallest-load IOC 303 to activate the memory DIF control (step S1205) and waits for the smallest-load IOC 303 to complete the memory DIF control (step S1206). After the smallest-load IOC 303 completes the memory DIF control, the determination unit 903 updates the record of the smallest-load IOC 303 in the IOC activation amount table 700 (step S1207). Specifically, the determination unit 903 decrements the number of activations of the memory DIF control of the smallest-load IOC 303 by 1, as well as subtracts the amount of data transferred in the executed memory DIF control from the total amount of transfer of memory DIF control of the smallest-load IOC 303.

When the smallest load of the IOC 303 is not smaller than the smallest load of the core 311 (NO in step S1203), the determination unit 903 updates the record of the smallest-load core 311 in the core activation amount table 800 (step S1208). Specifically, the determination unit 903 increments the number of activations of the memory DIF control of the smallest-load core 311 by 1, as well as adds the amount of data transferred in the memory DIF control to be executed, to the total amount of data transferred in the memory DIF control of the smallest-load core 311.

The determination unit 903 then causes the smallest-load core 311 to activate the memory DIF control (step S1209) and waits for the smallest-load core 311 to complete the memory DIF control (step S1210). After the smallest-load core 311 completes the memory DIF control, the determination unit 903 updates the record of the smallest-load core 311 in the core activation amount table 800 (step S1211). Specifically, the determination unit 903 decrements the number of activations of the memory DIF control of the smallest-load core 311 by 1, as well as subtracts the amount of data transferred in the executed memory DIF control from the total amount of data transferred in the memory DIF control of the smallest-load core 311.

Thus, the storage controller 201 ends the memory DIF control process.

FIG. 13 is a diagram illustrating an example of an operational flowchart for an IOC selection process performed by a storage controller, according to an embodiment. First, the determination unit 903 sets i representing the ID of an IOC 303 at 1 (step S1301). The determination unit 903 then calculates the total amount of data transferred in the memory DIF control for the IOCID “i”, by adding the amount of data transferred in the memory DIF control to be executed, to the total amount of transfer of memory DIF control in a record of the IOCID “i” which is stored in the IOC activation amount table 700 (step S1302). Then the determination unit 903 calculates the activation rate of the memory DIF control based on the calculated total amount of transferred data (step S1303). For example, the determination unit 903 calculates the activation rate of the memory DIF control by dividing the calculated total amount of data transferred in the memory DIF control by the maximum total amount of data transferred in the memory DIF control which the IOC 303 identified by IOCID “i” is able to execute within a unit time.

The determination unit 903 then calculates the utilization rate of the IOC 303 based on the total amount of transfer of I/O for the IOCID “i”, which is stored in the IOC activation amount table 700 (step S1304). For example, the determination unit 903 calculates the utilization rate for the IOCID “i” by dividing the total amount of transfer of I/O for the IOCID “i” in the IOC activation amount table 700 by the maximum total amount of data transferred in I/O which the IOC 303 identified by IOCID “i” is able to execute within the unit time. The determination unit 903 then determines, from the IOC load characteristic table 500, an index value LF_{I}, representing a load to be imposed on the IOC 303 identified by the IOCID “i”, which corresponds to a combination of the calculated activation rate of the memory DIF control and the calculated utilization rate (step S1305).

The determination unit 903 then increments i by 1 (step S1306) and determines whether i is greater than n indicating the number of IOCs (step S1307). When i is not greater than n (NO in step S1307), the process proceeds to step S1302, and the determination unit 903 determines an index value LF_{I} representing a load to be imposed on an IOC 303 identified by the incremented IOCID “i”.

When i is greater than n (YES in step S1307), the determination unit 903 selects an IOC 303 having the smallest index value LF_{I} among IOCs 303 having the determined index values LF_{I} (representing loads to be imposed on the IOCs 303), as an IOC 303 having the smallest load (step S1308). Then, the storage controller 201 ends the IOC selection process.

FIG. 14 is a diagram illustrating an example of an operational flowchart for a core selection process performed by a storage controller, according to an embodiment. First, the determination unit 903 sets i representing the ID of a core 311 at 1 (step S1401). The determination unit 903 then calculates the total amount of data transferred in the memory DIF control of the core ID “i”, by adding the amount of data transferred in the memory DIF control to be executed, to the total amount of data transferred in the memory DIF control in a record of the core ID “i” which is stored in the core activation amount table 800 (step S1402). Then the determination unit 903 calculates the activation rate of the memory DIF control based on the calculated total amount of transferred data (step S1403). For example, the determination unit 903 calculates the activation rate of the memory DIF control by dividing the calculated total amount of data transferred in the memory DIF control by the maximum total amount of data transferred in the memory DIF control which the core identified by the core ID “i” is able to execute within a unit time.

The determination unit 903 then determines, from the core load characteristic table 600, an index value LF_{C}, which represents a load to be imposed on the core ID “i”, corresponding to a combination of the calculated activation rate of the memory DIF control and the busy rate for the core ID “i” in the core activation amount table 800 (step S1404).

The determination unit 903 then increments i by 1 (step S1405) and determines whether i is greater than the number of cores, n (step S1406). When i is not greater than n (NO in step S1406), the process proceeds to step S1402, and the determination unit 903 determines an index value LF_{C} representing a load on a core 311 identified by the incremented core ID “i”.

When i is greater than n (YES in step S1406), the determination unit 903 selects a core 311 having the smallest index value LF_{I} among IOCs 303 having the determined index values LF_{I} (representing loads to be imposed on the cores 311), as a core 311 having the smallest load (step S1407). Then, the storage controller 201 ends the core selection process.

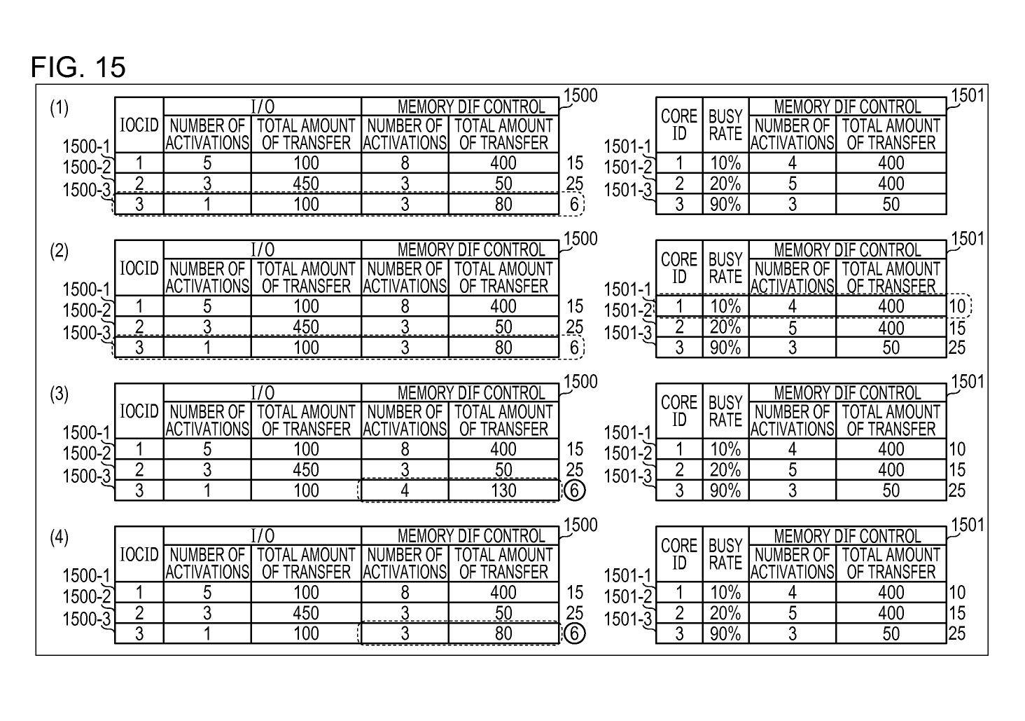

FIG. 15 is a diagram illustrating an example of an IOC/core selection process performed by a storage controller, according to an embodiment. In FIG. 15, the storage controller 201 includes three IOCs 303 and three cores 311 that are able to execute the memory DIF control. The IOC load characteristic table 500 of the three IOCs 303 is illustrated in FIG. 5, and the core load characteristic table 600 of the three cores 311 is illustrated in FIG. 6. It is assumed that the amount of data transferred in the memory DIF control to be executed is 50; the maximum total amount of data transferred in I/O that is attainable within one second by each IOC 303 is 500; and the maximum total amount of data transferred in the memory DIF control that is attainable within one second by each IOC 303 and each core 311 is 500.

In an example of FIG. 15, the determination unit 903 selects an IOC 303 having the smallest load and then determines a core 311 having the smallest load. The determination unit 903 then makes a comparison between the smallest-load IOC 303 and the smallest-load core 311 and determines the smallest-load IOC 303 as a smallest-load IOC 303 which is to execute the memory DIF control. The update unit 902 then updates the record of the determined IOC 303 in an IOC activation amount table 1500. After the IOC 303 completes the memory DIF control, the update unit 902 updates the record of the IOC 303 in the IOC activation amount table 1500.

(1) The determination unit 903 selects an IOC 303 having the smallest load. Specifically, the determination unit 903 calculates the activation rate of the memory DIF control for each IOC 303, based on the total amount of transferred data obtained by summing up the amount of data transferred in the memory DIF control to be executed and the total amount of data transferred in the memory DIF control in the activation amount table 1500. The determination unit 903 also calculates the utilization rate of each IOC 303 based on the total amount of transfer of I/O in the IOC activation amount table 1500. The determination unit 903 then determines, for each IOC 303, an index value LF_{I} representing a load on the IOC 303 corresponding to the calculated activation rate of the memory DIF control and the calculated utilization rate, from the IOC load characteristic table 500. The determination unit 903 then selects, as an IOC 303 having the smallest load, an IOC 303 having the smallest index values LF_{I} among index values LF_{I} calculated for the respective IOCs 303 and representing loads on the IOCs 303.

In the example of FIG. 15, the total amount of transfer of memory DIF control of the IOCID “i” in a record 1500-1 is 400, and the amount of data transferred in the memory DIF control to be executed is 50. Accordingly, the activation rate of the memory DIF control is (400+50)/500=0.9, that is, 90%. The total amount of transfer of I/O of the IOCID “i” in the record 1500-1 is 100. Accordingly, the utilization rate of the IOC 303 is 100/500=0.2, that is, 20%. An index value LF_{I} of “15”, representing a load on the IOC corresponding to the activation rate 90%, and the utilization rate 20%, is obtained from the IOC load characteristic table 500.

Similarly, for the IOCID “2” of a record 1500-2, an index value LF_{I} of “25” representing a load thereon is obtained. Similarly, for the IOCID “3” of a record 1500-3, an index value LF_{I} of “6” representing a load thereon is obtained. The determination unit 903 then determines the IOCID “3” having the smallest index value LF_{I} representing a load, as an IOC 303 having the smallest load.

(2) The determination unit 903 selects a core 311 having the smallest load. Specifically, the determination unit 903 calculates the activation rate of the memory DIF control of each core 311 based on the total amount of transferred data obtained by summing up the amount of data transferred in the memory DIF control to be executed and the total amount of transfer of memory DIF control in the core activation amount table 1501. The determination unit 903 then determines, for each core 311, an index value LF_{C} representing a load corresponding to the calculated activation rate of the memory DIF control and the calculated busy rate, from the core load characteristic table 600. The determination unit 903 then selects a core 311 having the smallest index value LF_{C} among index values LF_{C} representing loads calculated for the respective cores 311, as a core 311 having the smallest load.

In the example of FIG. 15, the total amount of transfer of memory DIF control of the core ID “1” in the record 1501-1 is 400, and the amount of data transferred in the memory DIF control to be executed is 50. Accordingly, the activation rate of the memory DIF control is (400+50)/500=0.9, that is, 90%. An index value LF_{C} “10”, representing a load corresponding to the activation rate 90%, and the busy rate 10%, is obtained from the core load characteristic table 600.

Similarly, for the core ID “2” of the record 1501-2, an index value LF_{C} “15” representing a load thereon is obtained. Similarly, for the core ID “3” of the record 1501-3, an index value LF_{C} “25” representing a load thereon is obtained. The determination unit 903 then determines the core ID “1” having the smallest index value LF_{C} representing a load, as a core 311 having the smallest load.

(3) The determination unit 903 makes a comparison between the index value LF_{I} “6” representing the load on the smallest-load IOCID “3” and the index value LF_{C} “10” representing the load on the smallest-load core ID “1”, and determines the smallest-load IOCID “3” as the target IOC which is to execute the memory DIF control. The update unit 902 then updates the record 1500-3 of the target IOCID “3” in the IOC activation amount table 1500. In the example of FIG. 15, the amount of execution of the memory DIF control in the record 1500-3 is incremented by 1, resulting in 4, and the total amount of data transferred in the memory DIF control is incremented by 50, resulting in 130.

(4) After the IOCID “3” completes the memory DIF control, the update unit 902 updates the record 1500-3 of the target IOCID “3” in the IOC activation amount table 1500. In the example of FIG. 15, the amount of execution of the memory DIF control in the record 1500-3 is decremented by 1, resulting in 3, and the total amount of transfer of memory DIF control therein is decremented by 50, resulting in 80.

As described above, the storage controller 201 according to the second embodiment is able to predict a load imposed on each core 311 of the processor 301 when the core 311 executes the memory DIF control. Further, the storage controller 201 is able to determine a target IOC 303 or core 311 which is to execute the memory DIF control and which is less likely to reduce the performance of the storage device, from the IOCs 303 and cores 311 based on the predicted loads thereon.

Further, the storage controller 201 allows one of the cores 311 of the processor 301 to determine whether it is most efficient to use an IOC 303 to execute the memory DIF control or whether it is most efficient to use a core 311 to execute the memory DIF control.

Since an IOC load characteristic table 500 and a core load characteristic table 600 are created when the storage controller 201 is shipped from the factory or started, the storage controller 201 is able to know index values LF_{I} or LF_{C} representing loads on the IOCs 303 and cores 311 prior to executing the memory DIF control.

Since the storage controller 201 selects a core 311 or IOC 303 which is to execute the memory DIF control and then updates the IOC activation amount table 700 or core activation amount table 800, the values in these tables are usually kept updated.

The control program described in the above embodiments is realized by causing a computer such as a personal computer or workstation to execute a beforehand prepared program. This control program is recorded on a computer-readable recording medium such as a hard disk, flexible disk, CD-ROM, MO, or DVD, and then executed when it is read from the recording medium by a computer. This control program may be distributed via a network, such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage controller comprising:
a plurality of control units each configured to perform a verification process in which validity of data is verified;
a first storage unit configured to store, for each of the plurality of control units, an index value in association with each of combinations of a first data-amount rate indicating a rate of an amount of data processed in the verification process executed by the each control unit and a utilization rate of the each control unit, the index value indicating a load to be imposed on the each control unit when the each control unit activates the verification process; and
a second storage unit configured to store, in association with each of the plurality of control units, a first amount value indicating an amount of data currently being processed in the verification process activated by the each control unit and the utilization rate of the each control unit, wherein
a first control unit included in the plurality of control units:
determines an index value, for each of the plurality of control units, by referring to information stored in the first storage unit based on a second amount value indicating an amount of data that is to be processed in a target verification process to be executed and information stored in the second storage unit; and
determines a second control unit that is to activate the target verification, from among the plurality of control units, based on the determined index values.

2. The storage controller of claim 1, wherein
the first control unit determines, for each of the plurality of control units, with reference to information stored in the first storage unit, the index value associated with a combination of the utilization rate of the each control unit stored in the second storage unit and a second data-amount rate that is calculated based on a sum of the second amount value and the first amount value of the each control unit stored in the second storage unit.

3. The storage controller of claim 1, wherein,
in response to determining the second control unit, the first control unit adds the second amount value to the first amount value of the second control unit stored in the second storage unit; and,
in response to the second control unit completing the target verification process, the first control unit subtracts the second amount value from the first amount value of the second control unit stored in the second storage unit.

4. The storage controller of claim 1, wherein
the first control unit:
causes a third control unit having a predetermined utilization rate to perform a verification process in which a predetermined amount of data is processed;
calculates a ratio of an amount of data which the third control unit has failed to process within a predetermined time, to the predetermined amount of data, as an index value indicating a load to be imposed on the third control unit; and
stores the calculated index value in the first storage unit in association with a combination of the predetermined utilization rate and a data amount rate corresponding to the predetermined amount of data.

5. The storage controller of claim 1, wherein
the each control unit is one of:
an input/output control unit configured to control input or output to or from a storage unit,
a processor configured to control the input/output control unit, and
a core included in the processor.

6. The storage controller of claim 1, wherein
the first control unit determines a control unit having the smallest index value among the plurality of control units, as the second control unit that is to activate the target verification process to be executed.

7. A method for controlling a storage controller including a plurality of control units each configured to perform a verification process in which validity of data is verified, the method comprising:
providing the storage controller with a first storage unit configured to store, for each of the plurality of control units, an index value in association with each of combinations of a first data-amount rate indicating a rate of an amount of data processed in the verification process executed by the each control unit and a utilization rate of the each control unit, the index value indicating a load to be imposed on the each control unit when the each control unit activates the verification process;
providing the storage controller with a second storage unit configured to store, in association with each of the plurality of control units, a first amount value indicating an amount of data currently being processed in the verification process activated by the each control unit and the utilization rate of the each control unit;
determining, by one of the plurality of control units, an index value, for each of the plurality of control units, by referring to information stored in the first storage unit based on a second amount value indicating an amount of data that is to be processed in a target verification process to be executed and information stored in the second storage unit; and
determining, by the one of the plurality of control units, a second control unit that is to activate the target verification process, from among the plurality of control units, based on the determined index values.

8. A non-transitory, computer-readable recording medium having stored therein a program for causing a computer included in a storage controller to execute a process, the storage controller including a plurality of control units each configured to perform a verification process in which validity of data is verified, the process comprising:
providing the storage controller with a first storage unit configured to store, for each of the plurality of control units, an index value in association with each of combinations of a first data-amount rate indicating a rate of an amount of data processed in the verification process executed by the each control unit and a utilization rate of the each control unit, the index value indicating a load to be imposed on the each control unit when the each control unit activates the verification process;
providing the storage controller with a second storage unit configured to store, in association with each of the plurality of control units, a first amount value indicating an amount of data currently being processed in the verification process activated by the each control unit and the utilization rate of the each control unit;
determining, by one of the plurality of control units, an index value, for each of the plurality of control units, by referring to information stored in the first storage unit based on a second amount value indicating an amount of data that is to be processed in a target verification process to be executed and information stored in the second storage unit; and
determining, by the one of the plurality of control units, a second control unit that is to activate the target verification process, from among the plurality of control units, based on the determined index values.
